(19) United States
(12) Patent Application Publication
(10) Pub. No.: US 2019/0143488 A1
(43) Pub. Date: May 16, 2019

(54) HEIGHT SPECIFIABLE PLATE SYSTEM AS REPLACEMENT FOR MOLDED VACUUM SUPPORT BOX

(71) Applicant: John Blick, Laguna Beach, CA (US)

(72) Inventor: John Blick, Laguna Beach, CA (US)

(21) Appl. No.: 15/811,109

(22) Filed: Nov. 13, 2017

(51) Int. Cl. B25B 11/00; B23Q 1/03

(52) U.S. Cl. CPC B25B 11/005; B65G 47/91; B23Q 1/032

(57) ABSTRACT

A predetermined height specialized support plate and post structural assembly replaces the plastic injection molded box-shaped structure used in a conventional vacuum support. The support plates interfit and support a conventional rubber vacuum engagement body in a manner similar to but more strengthened than otherwise. Predetermined height is achieved by specifying the length of support posts that stabilize, make handling easier, and may also preferably provide a source of vacuum to oppositely oriented vacuum engagement bodies.

### FIELD OF THE INVENTION

The present invention relates to improvements in a conventional vacuum hold down device, also known as a vacuum cup, having a thick rubber vacuum engagement body ends supported by a conventional fixed height plastic injection molded box which is usually designed and produced via costly injection molding tooling, and which has difficult to grasp exterior vertical walls; and more particularly the invention relates to an adjustable prespecified height system that includes a pair of oppositely disposed plates having outwardly disposed structure for supplanting either end of a conventional fixed height plastic injection molded box used to support a conventional vacuum cup having rubber vacuum engagement body ends in order to make better and more precise use of the thick rubber vacuum engagement bodies, the a pair of oppositely disposed plates having a magnitude of separation determined by support columns or posts attached between the a pair of oppositely disposed plates.

### BACKGROUND OF THE INVENTION

A conventional vacuum support devices may be used with process machinery to both support at the same time hold down a material under process of being worked. “Worked” can include any process, but processes of greater need for a vacuum hold down device structure are those which create lateral force which the vacuum hold down device structure is designed to resist. Many conventional vacuum support devices can be used with different CNC machines to elevate and hold a work piece. A vacuum hold down device not only has easier support fixation, but also can engage the work piece for vertical and horizontal stability.

Conventional, two sided vacuum supports may include a first thick rubber vacuum engagement body including a first side for engaging a workpiece and a second side, and a second thick rubber vacuum engagement body including a first side for engaging a flat work table to support a conventional two sided vacuum support, and a second side. A center portion structural support is provided upon which the second sides of the first and second thick rubber bodies removably attach. One typical type of conventional center portion support is made from injection molded plastic. A plastic injection mold process requires a time-consuming and expensive production of injection molding tooling.

For every height of the overall vacuum support, a different height size of time-consuming and expensive production of injection molding tooling must be performed. In essence, for a given height of vacuum support, even where the user had two identical and available thick rubber vacuum engagement bodies, a different height injection molded plastic box would be required. Details of the design of the different height injection molded plastic box would be likely to change with varying height of the box, and a time-consuming and expensive production would be further exacerbated by any height driven required design changes.

A center injection molded box support includes two, oppositely oriented patterns of vertical walls. A first pattern of vertical walls is provided to engage the first thick rubber vacuum engagement body and a second pattern of vertical walls is provided to engage the second thick rubber vacuum engagement body. A center floor isolates the first pattern of vertical walls from the oppositely directed second pattern of vertical walls so that vacuum may be independently applied to the first and second thick rubber vacuum engagement bodies.

The center portion support has an exterior wall extending about its periphery that forms one or more exterior walls. Interior walls, within the exterior walls, are arranged to form a rectangular array of vertical passages. Interior walls help to provide some support across the surface of the first or second thick rubber bodies. Some of the rectangular vertical passages can be bound by interior walls only, or by a combination of interior and exterior walls. The interior walls are arranged to have openings between at least some of the rectangular array of vertical passages designed to enable vacuum to be transmitted from one or more of the vertical passages to other vertical passages. One type of opening, possibly the simplest to form, is simply a slot extending from the outermost narrow end surface of an interior wall in a direction toward the center floor. The length of the slot in the direction of the center floor should be sufficient to avoid blockage of vacuum between adjacent vertical passages due to an interfitting engagement with its associated first or second thick rubber vacuum engagement body.

One or more of the exterior walls may support a first fitting for introducing vacuum into the rectangular array of vertical passages on a first side of the center floor, to control the vacuum supplied to the first thick rubber vacuum engagement body. Also, one or more of the exterior walls may support a second fitting for introducing vacuum into the rectangular array of vertical passages on a second side of the center floor, to control the vacuum supplied to the second thick rubber vacuum engagement body. In this way, the vacuum applied between a conventional vacuum support and the work piece can be controlled independently of the vacuum applied between a conventional vacuum support and the surface upon which a conventional vacuum support is supported.

A number of shortcomings are found in conventional vacuum supports that make them less advantageous than they would be otherwise. Flexible sealing thick rubber top and bottom vacuum engagement body structures ideally must have a support between them to provide both strength and distribution of vacuum evenly across the face of the vacuum engagement bodies to both bear the weight of the object supported and to provide a significant area of vacuum to hold the supported object down while it is being worked. One type of conventional vacuum support uses an injection molded plastic injection molded box-shaped structure with egg crate pattern of walls in order to provide for even support, in order to support the thick rubber top and bottom structures.

Vertical force integrity must be achieved by a combination of vertical structure that includes support about the outer periphery of the plastic injection molded box-shaped structure and structure within and away from the outer periphery of the plastic injection molded box-shaped structure. Further, the two sided plastic injection molded box-shaped structure is usually provided with a central separation wall so that the vacuum can be controlled independently for either of the flexible sealing thick rubber top and bottom structures.

A conventional vacuum support plastic injection molded box-shaped structure has vertical exterior walls that are linear along their height. The exterior wall causes a number of problems. First, it causes users to grasp the vacuum support with both hands when placing or removing the vacuum support structure, because there is no other structure which can be engaged manually to lift the structure. Any need for manipulating another object while handling a conventional vacuum hold down device will practically go unmet. This also causes undue dependence on sliding the vacuum support whenever both hands cannot be dedicated to grasping and lifting the support.

Providing different height vacuum supports is a very real problem in an industry where the process machinery produced by different companies have different height requirements for a workpiece to be supported. In some cases the lack of ability to support the workpiece at a given optimal height for a given piece of process equipment can limit maximum capabilities of the equipment. Providing varying heights of plastic injection molded box-shaped structures is impractical for two reasons. The first is the inherent limitation of simply providing the plastic injection molded box-shaped structure in different shapes or heights given the time and expense cost. The second involves the expense and complexity of providing a variety of plastic injection molded box-shaped structures, both in terms of manufacturing set-up, and customer cost, and vacuum support supply storage.

Friction press fit of the a conventionally available thick rubber vacuum engagement body onto an injection molded box can fail over time due to loosening of the thick rubber vacuum engagement body over time. The ability to provide better manual engagement and handling of the vacuum support can help users to better control the vacuum supports especially as they are handled for rearrangement and storage or deployment. A worker then must use both hands to engage and hold the vacuum hold down support together, including the thick rubber vacuum engagement bodies and injection molded box whenever a conventional vacuum support is lifted and carried.

What is needed is a systematic way to provide a better support than a plastic injection molded box-shaped structure to support a conventional available thick rubber vacuum engagement body. To help proliferate and encourage the use of vacuum supports means also that they must be made more inexpensively. The ability to provide different height supports more inexpensively, and with or without substitution of height determining elements would provide a good benefit to industries that use vacuum hold down support. The preferred replacement structure for the plastic injection molded box-shaped structure should provide easier manual handling and should provide height scalability of the resulting vacuum support.

### BRIEF DESCRIPTION OF THE DRAWINGS

The invention, its configuration, construction, and operation will be best further described in the following detailed description, taken in conjunction with the accompanying drawings in which:

FIG. 1 is an upper perspective view looking downward onto a conventional vacuum support that has a conventional central plastic injection molded box-shaped structure having a first side supporting a friction hold, press fit first conventionally available thick rubber vacuum engagement body and a second side supporting a second conventionally available thick rubber vacuum engagement body;

FIG. 2 is a top view looking down onto the conventional vacuum support of FIG. 1 and showing details of the friction hold, press fit first conventionally available thick rubber vacuum engagement body seen in FIG. 1;

FIG. 3 is a front view of the first conventionally available thick rubber vacuum engagement body seen in FIGS. 1 and 2, and is shown separated from the conventional central plastic injection molded box-shaped structure of FIG. 1;

FIG. 4 is a bottom view showing the underside of the first conventionally available thick rubber vacuum engagement body of FIGS. 1-3 and including detail structure for interfitting with the conventional central plastic injection molded box-shaped structure of FIG. 1;

FIG. 5 is an exploded view looking down onto the conventional vacuum support seen in FIGS. 1-4, revealing detail of an upper inside of the conventional central plastic injection molded box-shaped structure;

FIG. 6 is a perspective view looking down on a top side of a specialized vacuum support plate of the invention which is designed to provide operation and support to the conventional thick rubber top and bottom member seen in FIGS. 1-5;

FIG. 7 is a bottom perspective view of the specialized vacuum support plate of the invention seen in FIG. 6;

FIG. 8 is an exploded perspective view looking downward onto a vacuum support of the invention where each of two conventional thick rubber vacuum engagement members are supported by a pair of oppositely disposed specialized vacuum support plates oppositely affixed to support posts;

FIG. 9 illustrates a perspective exploded view of a conventional vacuum supply support post assembly with vacuum fittings and sealing “o” rings;

FIG. 10 illustrates a cross sectional view of the post of the conventional vacuum supply support post taken along line 10-10 of FIG. 9;

FIG. 11 is a perspective view looking down on the assembled vacuum support of the invention seen in an exploded view in FIG. 8;

FIG. 12 is a side view of the assembled vacuum support of the invention seen in FIGS. 6-11; and

FIG. 13 is a perspective view looking down on a further embodiment of a specialized vacuum support having expansive flat surface plates surrounded by a peripheral wall.

### SUMMARY OF THE INVENTION

A predetermined height specialized support plate and post structural assembly replaces the plastic injection molded box-shaped structure of a conventional vacuum support. Predetermined height is achieved by specifying the length of the posts that stabilize and provide a source of vacuum to the specialized support plates. The specialized support plates are each designed to interfit and support a conventional thick rubber vacuum engagement body that would otherwise have been supported by the plastic injection molded box-shaped structure used in a conventional vacuum support. The posts of the plate and post structural assembly provide the space and structures to facilitate manual handling and positioning of the resulting inventive vacuum support.

The specialized support plates have an outward shape configuration that is complementary to and improves the structural support provided to conventionally available thick rubber vacuum engagement bodies. The specialized support plates provide vacuum fluid communication and thus vacuum propagation across the area underneath the conventionally available thick rubber vacuum engagement bodies. However, vacuum fluid communication and vacuum propagation are obtained without having to resort to deep cellular spaces bounded by a combination of inside and outside walls that were present within the plastic injection molded box-shaped structure conventional vacuum supports.

Shorter metal or molded wall structures are present on the specialized support plates and provide increased strength and stability, and additional closer support underneath the conventionally available thick rubber vacuum engagement bodies. Shorter wall structures are no longer than is necessary to support the conventionally available thick rubber vacuum engagement bodies. The shorter wall structures carry slots that may only extend to a generally planar floor from which the shorter walls may arise.

A first embodiment of a specialized support plate and post structural assembly includes details relating to a particular conventionally available thick rubber vacuum engagement body. A second embodiment includes a somewhat plain, tray shaped support to emphasize that a base model might either be utilizable with many other particular conventionally available thick rubber vacuum engagement bodies either without, or with some slight further modification to a tray shape. As by example, a pattern of grooves formed either along defined paths, or randomly in a generic tray could be easily formed and present to assist vacuum distribution for nearly any conventionally available thick rubber vacuum engagement body.

### DETAILED DESCRIPTION OF THE PREFERRED EMBODIMENT

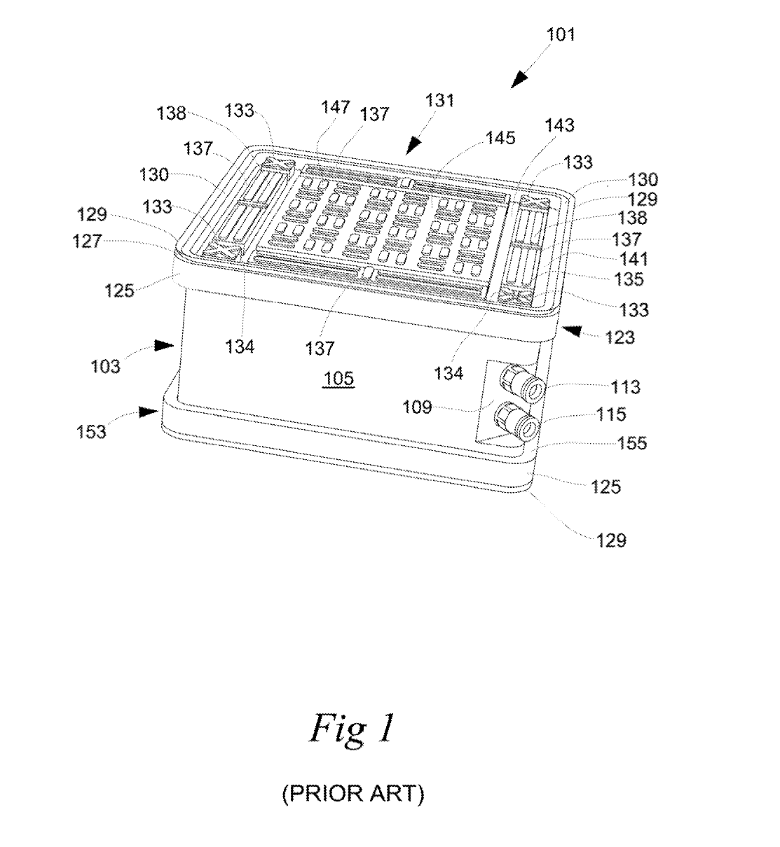

Referring to FIG. 1, an upper perspective view looking downward onto a conventional vacuum support 101 is shown in a condition ready for vacuum hose attachment and deployment on a unit of processing machinery to perform a vacuum hold down function. A central plastic injection molded box-shaped structure 103 may have a generally smooth outer wall 105. At one corner of the box-shaped structure 103, an angled flat surface 109 is seen to support a first vacuum fitting 113, and a second vacuum fitting 115.

At a first, upper as to FIG. 1, side of the central plastic injection molded box-shaped structure 103, a friction hold, press fit first conventionally available thick rubber vacuum engagement body 123 is attached. From the lowest portion of thick rubber vacuum engagement body 123 seen, a main wall 125 leads upward to a groove 127 provides that a gap to enable operation of an integral upper planar area as an integral seal portion 129 of thick rubber vacuum engagement body 123. The groove 127 provides space into which integral seal portion 129 may flexibly move. Integral seal portion 129 extends about the upper periphery of the thick rubber vacuum engagement body 123. An outer wall top surface 130 provides a height of support structure from which the integral seal portion 129 extends outwardly and slightly upwardly.

Integral seal portion 129 is part of a workpiece engagement side 131 of the thick rubber vacuum engagement body 123. Peripherally inside the integral seal portion 129, a number of other structures are seen. Corner projection 133 extends upwardly from an raised island structure 134 to provide a structure that may be used to centrally locate a vacuum transmission aperture 135. Other corner projections 133 extend upwardly from raised island structure 134 not having a vacuum transmission aperture 135. Other structures may be present to facilitate transmission of vacuum and/or insure that any vacuum opening is not blocked by engagement with a supported workpiece.

At the top of raised island structures 137, multiple raised projections 138 extend upwardly. Raised island structure 137 provides support and identifies outer peripheral channels 141 and inner peripheral channels 143 used to facilitate vacuum flow near the outer periphery of the workpiece engagement side 131 of the thick rubber vacuum engagement body 123. At the center of the workpiece engagement side 131 of the thick rubber vacuum engagement body 123, a large central block 145 is seen. There are multiple very slightly raised oval anti-skid wear structures 147, that facilitate vacuum communication from aperture 135, as well as provide for friction engagement of a workpiece to be supported (not shown in FIG. 1).

Note that an optional seal (not shown) could be inserted in outer peripheral channels 141 were the integral seal portion 129 to fail. Closer to the bottom of FIG. 1, a second side of the central plastic injection molded box-shaped structure 103, a second conventionally available thick rubber vacuum engagement body 153 is also friction press fit engaged to the central plastic injection molded box-shaped structure 103. Preferably, the second conventionally available thick rubber vacuum engagement body 153 is identical to the first conventionally available thick rubber vacuum engagement body 123. Any structure on the second conventionally available thick rubber vacuum engagement body 153 is the same as was shown earlier for the first conventionally available thick rubber vacuum engagement body 123. Also seen for the first time is an underlying wall surface 155 which is adjacent to the main wall 125.

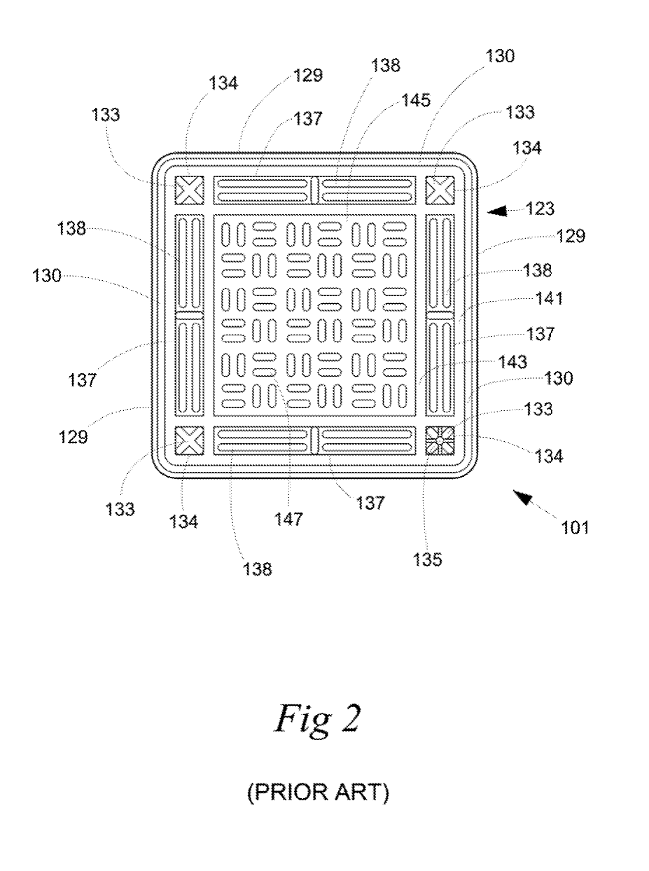

Referring to FIG. 2, a top view looking down onto the conventional vacuum support conventional vacuum support 101 is such that only the friction hold, press fit first conventionally available thick rubber vacuum engagement body 123 is seen, because structures that underlie it are visually covered. The outer narrow end surface and top of the integral seal portion 129 are seen evenly extending about the periphery. Other details of the workpiece engagement side 131 (by reference to FIG. 1) are seen, including the corner projections 133, vacuum transmission aperture 135, peripheral raised projections 138 and the outer and inner peripheral channels 141 and 143. The large central block 145 is the largest contiguous (island) bearing protrusion. As mentioned earlier, a supplemental seal member placed within and blocking the outer peripheral channels 141, would still leave the inner peripheral channels 143 to quickly transmit vacuum peripherally.

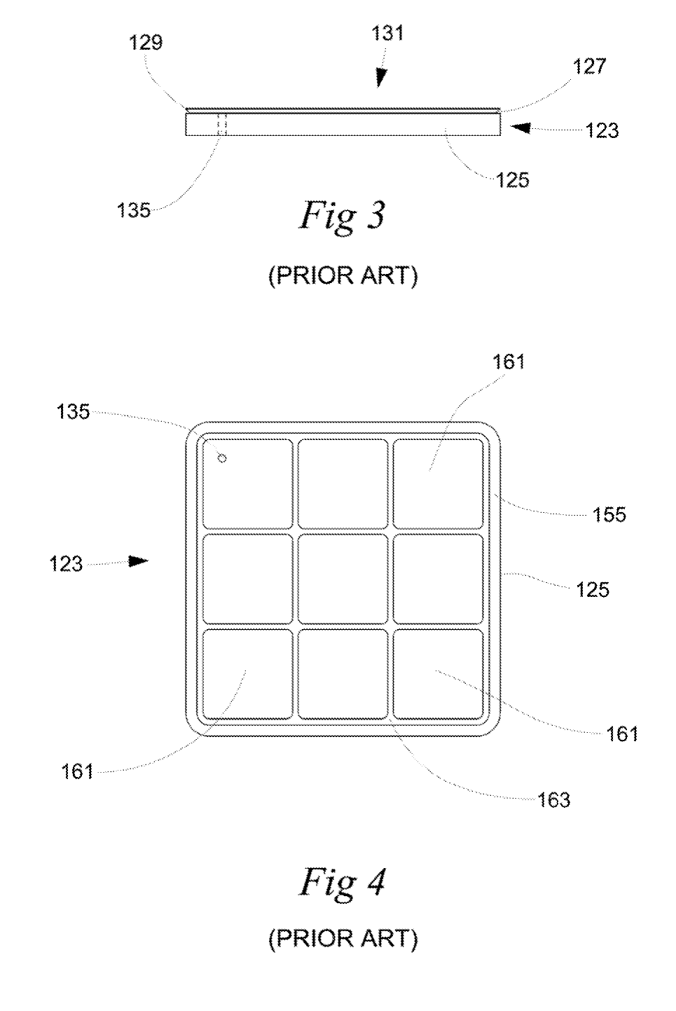

Referring to FIG. 3, a front view of the friction hold, press fit first conventionally available thick rubber vacuum engagement body 123 seen in FIGS. 1 and 2 gives some further detail of the relationship between main wall 125, groove 127 and integral seal portion 129. The vacuum transmission aperture 135 seen in FIGS. 1 and 2 is shown in broken line format to illustrate its extension through the depth of the thick rubber vacuum engagement body 123. Referring to FIG. 4, a bottom view of the friction hold, press fit first conventionally available thick rubber vacuum engagement body 123 shows details of its engagement underside. Vacuum transmission aperture 135 is seen extending through one of several shallow protrusions 161. The shallow protrusions 161 assist with friction fit onto adjacent wall structures (to be shown) within the central plastic injection molded box-shaped structure 103.

The shallow protrusions 161 in this configuration are nine in number and each protrusion has a square profile with rounded corners. Each of the shallow protrusions 161 extend away from an underside floor 163. The underlying wall surface 155 may or may not have an extent equal to the shallow protrusions 161. In this configuration, the underside floor 163 represents the beginning of a base of a depth of fit of the underlying wall surface 155 and shallow protrusions 161 into the top of the central plastic injection molded box-shaped structure 103. This depth of fit sets the lateral area of friction fit.

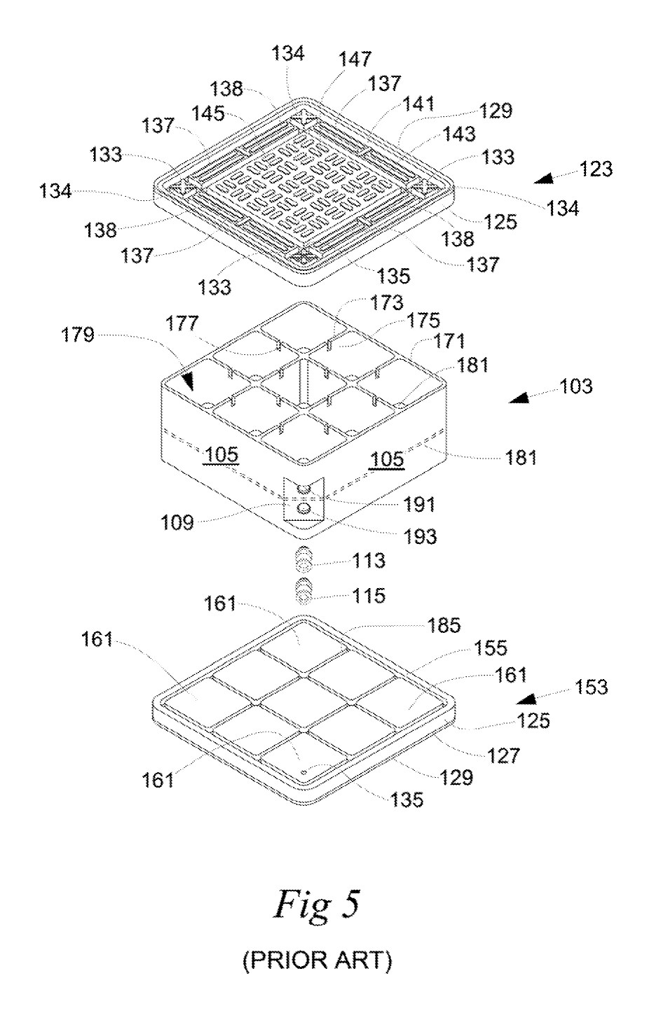

Referring to FIG. 5, an exploded view looking down onto the conventional vacuum support 101 seen in FIGS. 1-4, reveals detail looking down and into an upper inside of the conventional central plastic injection molded box-shaped structure 103. The same details seen for the upper inside of the central plastic injection molded box-shaped structure 103 in FIG. 5 will exist for a lower inside view. Further, since the friction hold, press fit first and second conventionally available thick rubber vacuum engagement bodies 123 and 153 are identical, their presence in this exploded view will illustrate interfit details from above and below.

The generally smooth outer wall 105 has a continuous top narrow end surface 171 at a same level as a series of top narrow end surfaces 173 of series of inner walls 175. The top narrow end surfaces 173 of the series of inner walls 175 may each have a slot 177 extending into and away from the top narrow end surfaces 173 of the level of the top narrow end surfaces 171 and 173 of the outer and inner walls 175 and outer wall 105. The spaces bound by the inner walls 175 and outer wall 105 will be referred to as compartments 179.

Compartments 179 extend from the top narrow end surfaces 171 and 173 of the outer and inner walls 175 and outer wall 105 to a floor separation 181. Floor separation 181 is shown in dash line format about the mid vertical extent of the outer wall 105. Thus the floor separation 181, along with inner and outer wall structures 105 and 175, provides a barrier that isolates each compartment 179 from others at least below the slots 177.

The slots 177, to the extent that they are long enough to extend beyond any blockage by the shallow protrusions 161, can provide openings and fluid vacuum communication between the compartments 179. In terms of fit, the underside floor 163 of the friction hold, press fit first and second conventionally available thick rubber vacuum engagement bodies 123 and 153 will bearingly rest upon the top narrow end surfaces 171 and 173 of the outer and inner walls 175 and outer wall 105. The surfaces that will provide lateral frictional engagement include a combination of (1) sections of an inside surface 185 of the main wall 125 that extends from the underside floor 163 to the underlying wall surface 155 that engage the generally smooth outer wall 105, and (2) the lateral sides of the shallow protrusions 161 that engage the outer and inner walls 175 and outer wall 105.

As a result, the frictional holding power of the central plastic injection molded box-shaped structure 103 to keep the friction hold, press fit first and second conventionally available thick rubber vacuum engagement bodies 123 and 153 in place will depend upon the depth of material of the shallow protrusions 161 and inside surface 185, with respect to the underside floor 163, available to laterally engage material of the central plastic injection molded box-shaped structure 103. Any structures that allow a more secure physical handling of any given vacuum support could reduce the stress on and incidence of inadvertent separation of the components of the conventional vacuum support 101. Also seen is a first threaded aperture 191 to facilitate interfit with first vacuum fitting 113, and a second threaded aperture 193 to facilitate interfit with second vacuum fitting 115. It is reminded that central plastic injection molded box-shaped structure 103 may have symmetrical features about the floor separation 181 and such that all of the details of structure 103 from the top perspective of FIG. 5 would also be seen on the underside. Outer wall top surface 130, corner projections 133, peripheral long blocks 138 and very slightly raised oval anti-skid wear structures 147 are preferably the same height.

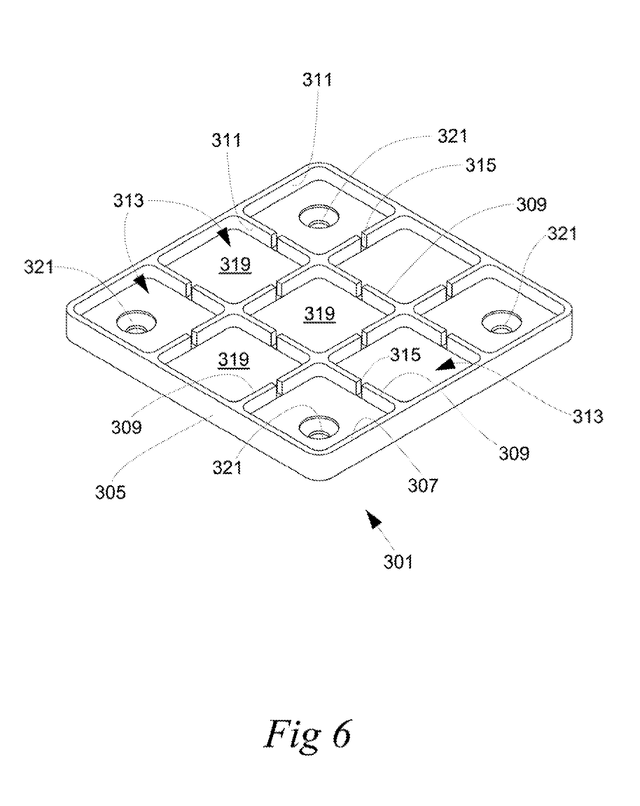

Referring to FIG. 6 a perspective view looking down a top side of a specialized vacuum support plate 301 of the invention is seen. Vacuum support plate 301 is designed to provide operation and support to the friction hold, press fit first and second conventionally available thick rubber vacuum engagement bodies 123 and 153 seen in FIGS. 1-5. Vacuum support plate 301 emulates needed functional topological details that were present with respect to the central plastic injection molded box-shaped structure 103 of FIG. 5, while providing changes and improvements that create a more sturdy and useful new vacuum support.

The vacuum support plate 301 has a generally smooth, abbreviated height outer wall 305, a continuous peripheral top narrow end surface 307, and inside narrow end surfaces 309 of a series of abbreviated height walls 311. The walls 311 and outer wall 305 form a series of compartments 313. Slots 315 are formed in the inner walls of the nine adjacent compartments 313 in a pattern that will allow fluid vacuum communication with any of the peripheral compartments 313.

The inner walls 311 and outer wall 305 rise from a plate floor 319. Note that the slots 315 will be deep enough to permit vacuum fluid communication in a space between the greatest extent of the shallow protrusions 161 and the plate floor 319. The plate floor 319 does not form an overly deep compartment 313, such as the compartments 179 of the central plastic injection molded box-shaped structure 103.

A series of four chamfered apertures 321 are provided through the plate floor 319 for attachment to post structures (to be shown). Ideally, one of the four chamfered apertures 321 can be utilized to transmit vacuum to one of the compartments 313 whereby all eight of the peripheral compartments may have a vacuum supply that can be transmitted through the friction hold, press fit first and second conventionally available thick rubber vacuum engagement bodies 123 and 153. The top narrow end surface 307 and inside narrow end surfaces 309 of the vacuum support plate 301 will engage the underside floor 163 of the thick rubber vacuum engagement bodies 123 or 153.

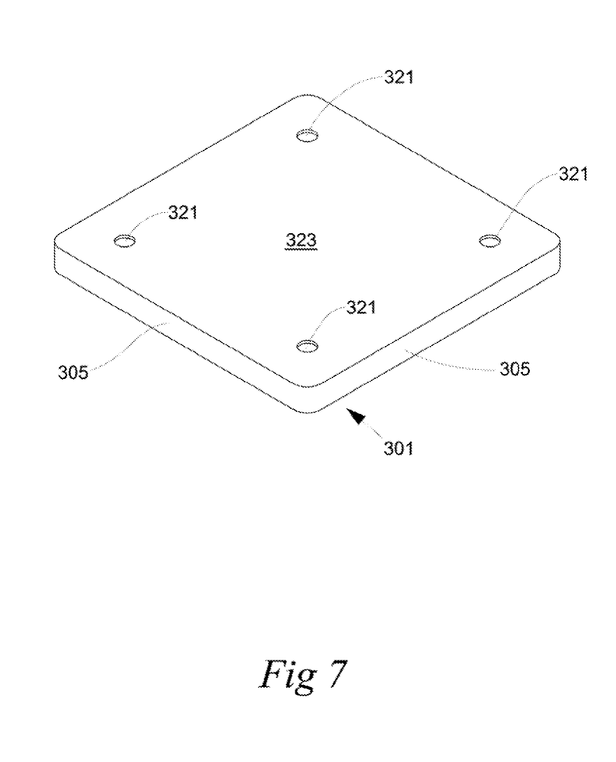

Referring to FIG. 7, a perspective view of a bottom side 323 of the specialized vacuum support plate 301 is shown. The underside of the apertures 321 are seen. The bottom side 323 is shown as flat, but need not be. If necessary, vacuum could be introduced through another aperture (not shown) that may not be associated with the apertures 321.

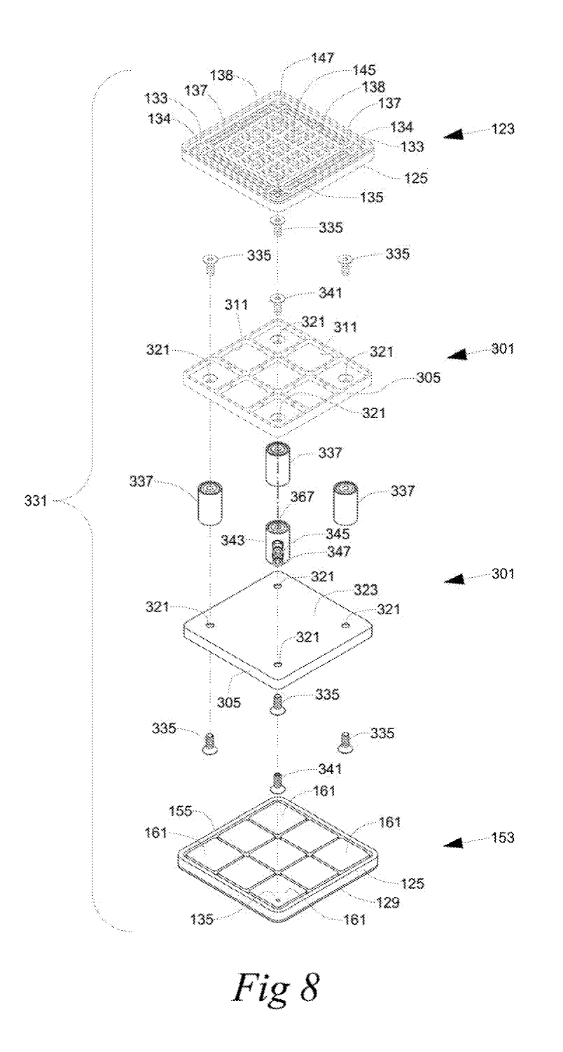

Referring to FIG. 8, an exploded perspective view looking downward onto a vacuum support 331 of the invention is shown. Each of two friction hold, press fit first and second conventionally available thick rubber vacuum engagement bodies 123 and 153 is supported by an associated one of a pair of oppositely disposed specialized vacuum support plates 301. From the top, and below a thick rubber vacuum engagement body 123, a series of three ordinary screws 335 are seen. Ordinary screws 335 are each used to attach the vacuum support plate 301 to an associated non-vacuum transmission posts 337.

A vacuum transmission screw 341 has a vacuum transmission aperture extending axially through it. Vacuum transmission screws 341 are used above and below to attach the vacuum support plate 301 to an associated vacuum transmission post 343. Vacuum transmission post 343 is seen with a first vacuum fitting 345 and a second vacuum fitting 347. It is readily seen that the height of the non-vacuum transmission posts 337 and vacuum transmission post 343 set the overall height of the vacuum support 331 of the invention.

A second vacuum plate 301 is shown below the posts 337 and 343 with its bottom side 323 directly upwardly against the bottom end openings (not seen in FIG. 8) of the posts 337 and 343 aligned with apertures 321 of the lower second vacuum plate 301. As before, and at both sides of the exploded view of FIG. 8, screws 335 align with posts 337 while a vacuum transmission screw 341 aligns with vacuum post 343. The vacuum transmission screw 341 supplies fluid vacuum to spaces adjacent the shallow protrusions 161, and thus also through vacuum transmission aperture 135 to the workpiece engagement side of the friction hold, press fit first and second conventionally available thick rubber vacuum engagement bodies 123 and 153.

For a given area size of the two identical vacuum support plates 301 and associated friction hold, press fit first and second conventionally available thick rubber vacuum engagement bodies 123 and 153, varying heights of the set of three non-vacuum transmission posts 337 and vacuum transmission post 343 will enable an assembled vacuum support 331 of nearly any predetermined height. The assembled vacuum support 331 will be more easily physically manipulated by enabling the manual grasping of a vacuum engagement body 123 and vacuum support plate 301 at one time, or by enabling the manual grasping of posts 337 or 343. Further, the use of separated vacuum support plates 301 eliminates the need for expensive injection molded tooling of different height injection molded box structures 103 and allows for timely production of vacuum supports of varying heights.

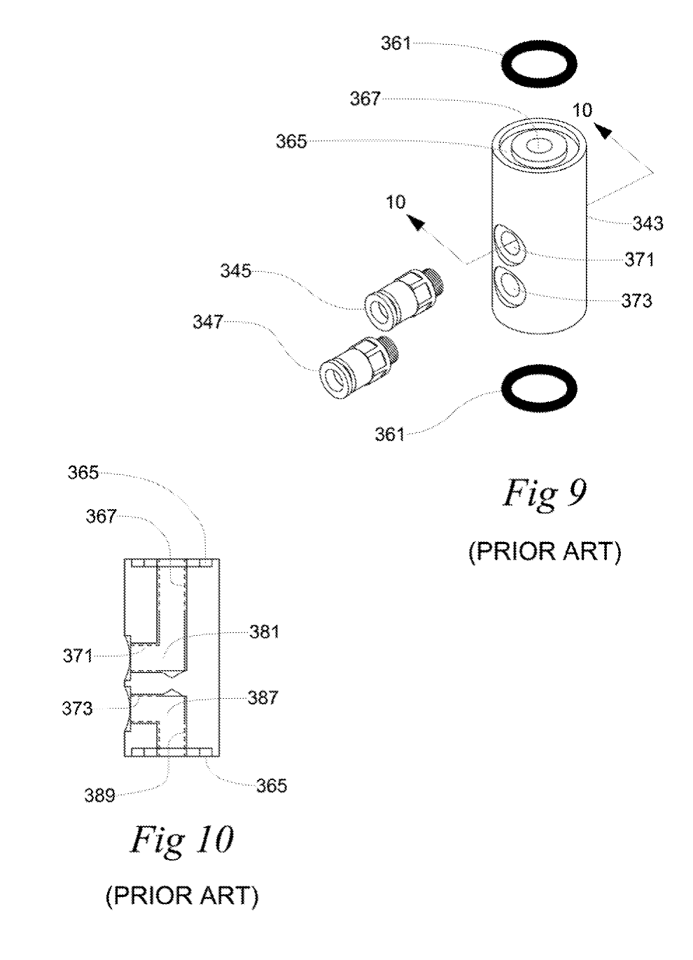

Referring to FIG. 9, a detail perspective view of a conventional vacuum supply support post 343 assembly is shown as having vacuum fittings 345 and 347 and sealing “o” rings 361 above and below the vacuum transmission post 343. An “o” ring groove 365 is seen at top of the vacuum transmission post 343 adjacent a threaded vacuum transmission bore 367 seen at the top of the vacuum transmission post 343. The sealing “o” rings 361 seal the upper and lower ends of the vacuum transmission post 343 against the bottom side 323 of the vacuum support plate 301. A pair of vacuum fitting threaded bores including a first threaded bore 371 and a second threaded bore 373 are also seen aligned with the vacuum fittings 345 and 347, respectively.

Referring to FIG. 10, a cross sectional view of the vacuum transmission post 343 taken along line 10-10 of FIG. 9 is shown. The threaded vacuum transmission bore 367 can be seen in communication with a passage 381 in communication with first threaded bore 371. A threaded vacuum transmission bore 389 can be seen in communication with a passage 387 in communication with second threaded bore 373. Passage 387 is in communication with a lower threaded vacuum transmission bore 389 at a second end of the vacuum transmission post 343. With this configuration, the vacuum fittings 345 and 347 can be independently actuated with a vacuum to independently apply vacuum to either side of the vacuum support 331 independent of the other.

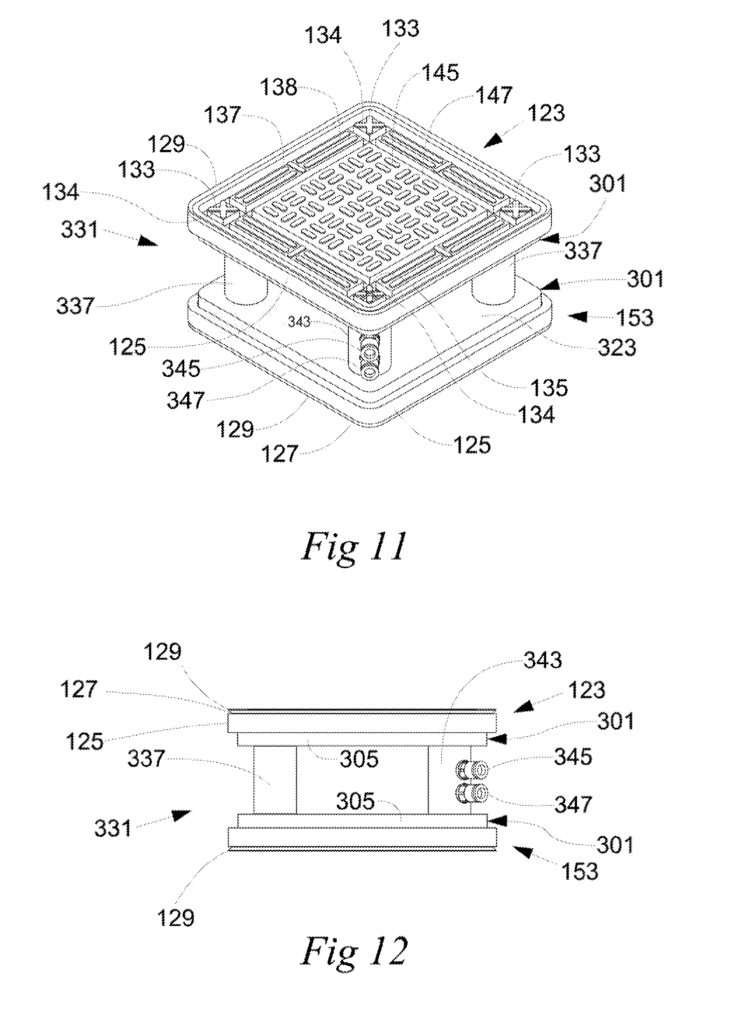

Referring to FIG. 11, a perspective view looking down on the assembled vacuum support 331 of the invention that is previously seen in an exploded view of FIG. 8 is seen. Referring to FIG. 12, a side elevation view of the assembled vacuum support 331 of the invention seen in FIGS. 6-11 helps to illustrate the spacing between the support posts, and that the length of the support posts set the height of the vacuum support 331.

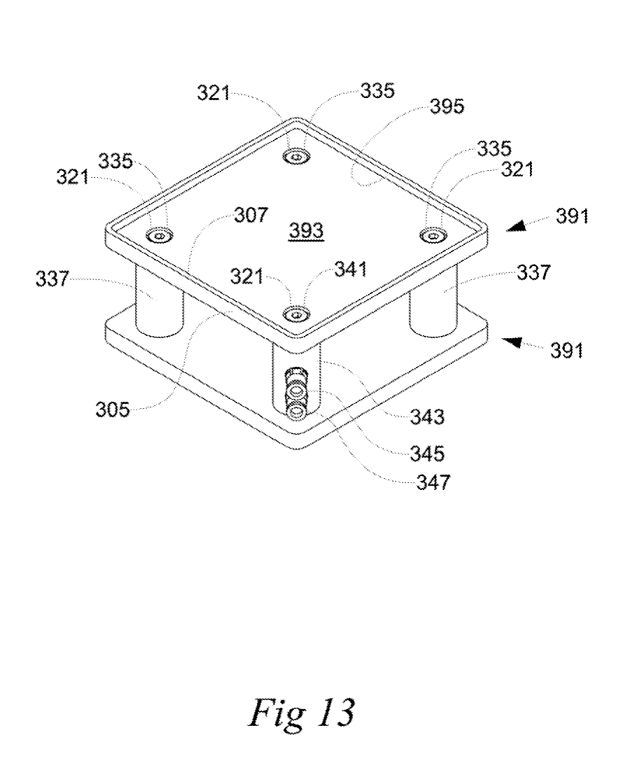

Referring to FIG. 13, a perspective view of a further embodiment of the invention involves a pair of vacuum support plates 391 shown in assembly with non-vacuum transmission posts 337, ordinary screws 335, vacuum transmission post 343, and vacuum transmission screw 341. The screws 341 and 335 partially obscure four chamfered apertures 321 which are only partially seen. Vacuum support plate 391 has an expansive flat surface 393 surrounded by an abbreviated height wall 395. Any vacuum bearing structure securely supported by support plate 391 and which makes accommodation to distribute fluid vacuum from the Vacuum transmission screw 341 across the expansive flat surface 393, or underneath any vacuum bearing structure, through any vacuum bearing structure, or over the top surface of any vacuum bearing structure supported by support plate 391, could form an effective vacuum hold down device. The simplicity of the support plate 391 emphasizes that fluid vacuum flow paths could be formed by grooving surface 393, or by providing grooves on the underside of a any vacuum bearing structure, or providing grooves or channels at the top side of any vacuum bearing structure, so long as a surrounding sealing of inside fluid vacuum pathways could be established.

While the present invention has been described in terms of a vacuum support structure ideal for providing a better support for conventionally available thick rubber vacuum engagement bodies, the structures techniques employed herein are applicable to a wide range of devices, machines, and methods to provide easily producible, easily assembled, and field repairable vacuum supports, including tolerancing for field replaceability of components. Although the invention has been derived with reference to particular illustrative embodiments thereof, many changes and modifications of the invention may become apparent to those skilled in the art without departing from the spirit and scope of the invention. Therefore, included within this patent are all such changes and modifications as may reasonably and properly be included within the scope of this contribution to the art.

What is claimed:

1. A structure for supporting a first friction hold, press fit first conventionally available rubber vacuum engagement body, comprising:
a first vacuum support plate having an abbreviated height first outer wall and a first series of abbreviated height inner walls to form a first plurality of compartments, at least some of the first series of abbreviated height inner walls having slots of sufficient depth to enable the compartments to be in fluid communication in the presence of the first attached conventionally available rubber vacuum engagement body; at least one of the first plurality of compartments for introducing a source of vacuum through the first vacuum support plate for distribution underneath the first attached conventionally available rubber vacuum engagement body when attached to the vacuum support plate.

2. The structure for supporting a first friction hold, press fit first conventionally available rubber vacuum engagement body as recited in claim 1, and further comprising:
a second vacuum support plate, identical to the first vacuum support plate, for supporting a second friction hold, press fit second conventionally available rubber vacuum engagement body, and
at least one post having a first end attached to the first vacuum support plate, and a second end attached to the second vacuum support plate in order to set a height of a resulting vacuum hold down device based upon a height separation distance between the first and second friction hold, press fit first conventionally available rubber vacuum engagement bodies when they are attached to the first and second vacuum support plates, respectively.

3. The structure for supporting a first friction hold, press fit first conventionally available rubber vacuum engagement body as recited in claim 2, wherein the at least one post can vary in length to determine to set a predetermined height of a resulting vacuum hold down based upon a height separation distance between the first and second friction hold, press fit first conventionally available rubber vacuum engagement bodies when they are attached to the first and second vacuum support plates, respectively.

4. The structure for supporting a first friction hold, press fit first conventionally available rubber vacuum engagement body as recited in claim 2, wherein
first and second friction hold, press fit first conventionally available rubber vacuum engagement bodies have an underside grid pattern.

5. The structure for supporting a first friction hold, press fit first conventionally available rubber vacuum engagement body as recited in claim 4, wherein the underside grid pattern matches the abbreviated height inner walls of the first and second first vacuum support plates.

6. The structure for supporting a first friction hold, press fit first conventionally available rubber vacuum engagement body as recited in claim 4, wherein
the underside grid pattern that cooperates with the slots of the abbreviated height inner walls to enable the compartments to be in fluid communication.

7. The structure for supporting a first friction hold, press fit first conventionally available rubber vacuum engagement body as recited in claim 2, wherein
the first and second vacuum support plate and the at least one post are each individually toleranced to facilitate replacing a first and second friction hold, press fit first conventionally available rubber vacuum engagement body without a need for additional adjustment to an overall tolerance height of the resulting vacuum hold down device.

8. The structure for supporting a first friction hold, press fit first conventionally available rubber vacuum engagement body as recited in claim 2, wherein the first and second vacuum support plate and the at least one post are each individually toleranced to facilitate replacing a first and second friction hold, press fit first conventionally available rubber vacuum engagement body without further adjustment to an overall tolerance height of the resulting vacuum hold down device.

9. A structure for oppositely supporting a first and second friction hold, press fit molded conventionally available rubber vacuum engagement bodies, comprising:
a first vacuum support plate having an abbreviated height first outer wall and a first series of abbreviated height inner walls to form a first plurality of compartments, at least some of the first series of abbreviated height inner walls having slots of sufficient depth to enable the compartments to be in fluid communication in the presence of the first friction hold, press fit molded conventionally available rubber vacuum engagement bodies;
a second vacuum support plate having an abbreviated height second outer wall and a second series of abbreviated height inner walls to form a second plurality of compartments, at least some of the second series of abbreviated height inner walls having slots of sufficient depth to enable the compartments to be in fluid communication in the presence of the second friction hold, press fit molded conventionally available rubber vacuum engagement bodies;
at least one post having a first end attached to the first vacuum support plate, and a second end attached to the second vacuum support plate in order to set a height of a resulting vacuum hold down device based upon a height separation distance between the first and second friction hold, press fit first conventionally available rubber vacuum engagement bodies when they are attached to the first and second vacuum support plates, respectively.

10. The structure for supporting a first friction hold, press fit first conventionally available rubber vacuum engagement body as recited in claim 9, wherein
the first and second vacuum support plate and the at least one post are each individually toleranced to facilitate replacing a first and second friction hold, press fit first conventionally available rubber vacuum engagement body without further adjustment to an overall tolerance height of a resulting vacuum hold down device.

11. The structure as recited in claim 9, wherein the vacuum transmission structure includes the at least one post with a path through the at least one post and through the first vacuum support plate.

12. The structure of claim 9 and further comprising first and second friction hold, press fit molded conventionally available rubber vacuum engagement bodies supported by the first and second vacuum support plates, respectively.

13. The structure of claim 11, wherein first and second friction hold, press fit first conventionally available rubber vacuum engagement bodies have an underside grid pattern matching the abbreviated height inner walls of the first and second first vacuum support plates.
